(19) United States
(12) Patent Application Publication
(10) Pub. No.: US 2026/0209608 A1
(43) Pub. Date: Jul. 23, 2026

(54) Automatic Corrosion Control in Hydrocarbon Pipelines by Monitoring Parameters of System Fluids

(71) Applicant: Saudi Arabian Oil Company, Dhahran (SA)

(72) Inventors: Rashed D. Hajri, Abqaiq (SA); Meshary A. Albahli, Al Khobar (SA); Abdullah M. Alratoee, Al Khobar (SA); Eid A. Al Hazmi, Dammam (SA); Omar S. Abdulgader, Dammam (SA); Yousef A. Aldossary, Dhahran (SA); Daffer S. Al Yami, Al Khobar (SA)

(21) Appl. No.: 19/034,727

(22) Filed: Jan. 23, 2025

(51) Int. Cl. C10G 7/10; C10G 7/12; G01N 17/00; G01N 17/04

(52) U.S. Cl. CPC C10G 7/10; C10G 7/12; G01N 17/006; G01N 17/04; C10G 2300/4075

(57) ABSTRACT

A computer system implements a method for monitoring corrosion in overhead piping of a Crude Distillation Unit by receiving a temperature measurement and a pressure measurement measured by multiple sensors connected to an overhead piping of a CDU. The overhead piping flows a hydrocarbon stream between an atmospheric tower and an overhead drum of the CDU. The computer system determines a sublimation temperature threshold using the pressure measurement. The sublimation temperature represents a temperature at which corrosive salts are formed in the overhead piping due to the flow of the hydrocarbon stream. The computer system compares the determined sublimation temperature threshold and the received temperature measurement. Based on a result of the comparing, the computer system can control a water wash valve fluidically coupled to the overhead piping to control a quantity of water injected through the water wash valve into the overhead piping.

### TECHNICAL FIELD

This disclosure relates to hydrocarbon processing in refineries and processing plants.

### BACKGROUND

Hydrocarbon is processed in refineries and processing facilities. Such facilities can include various processing plants, like crude oil distillation units, vacuum distillation units, and hydrocracking units. Hydrocarbon can be flowed through the refinery and between the processing plants via piping. The chemical properties of the hydrocarbon streams can be corrosive in nature and may introduce operational difficulties and damage to equipment if not properly handled. Thus, proper handling of corrosion enables successful operation of hydrocarbon processing facilities.

### SUMMARY

This disclosure describes technologies relating to the automatic corrosion control in hydrocarbon pipelines by monitoring parameters of system fluids.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 illustrates an example of the system for monitoring and mitigating corrosion in a processing plant of a refinery through which hydrocarbon streams flow in piping.

FIG. 2 is a flowchart of an example of a process of monitoring and mitigating corrosion based on a sublimation temperature parameter.

FIG. 3 is a flowchart of an example of a process of monitoring and mitigating corrosion based on a corrosion rate parameter.

FIG. 4 is a flowchart of an example of a process of monitoring and mitigating corrosion based on a pH parameter.

Like reference numbers and designations in the various drawings indicate like elements.

### DETAILED DESCRIPTION

This disclosure relates to automatic real-time corrosion control and mitigation within hydrocarbon systems. Corrosion is typically caused by acids and salts that are corrosive and hygroscopic. The presence of these acids and salts in a hydrocarbon system may result in the effects of fouling, erosion corrosion, and under-deposit corrosion. Traditionally, corrosion is avoided by utilizing a combination of water wash, corrosion inhibitors, and neutralizing amine which is injected into a system that encounters the corrosive acids and salts. However, setting and optimizing the operation mode and flowrate for water wash and inhibitors present challenges due to variances in a hydrocarbon system such as differences in crude oil feedstock properties, crude distillation throughputs and operations, and the amount of refinery slop blended in feedstock. Operators in a hydrocarbon system typically collect corrosion and process data and perform a trial and error-based analysis to manually adjust the water wash mode and flowrate. This is a time-consuming process that can result in a delayed and a less effective response to corrosion.

The automatic monitoring and control described in the disclosure allows for an automatic method for alleviating corrosion by using sensors installed within the system to measure parameters that are indicative of corrosion characteristics such as temperature, pressure, pH, fluid content, and pipe thickness loss and corrosion rate. The sensor data is then used by a microcontroller to automatically and in real-time determine the optimal quantity of water wash or other corrosion inhibitor or combinations of them required to alleviate the effects of corrosion.

Implementations of the subject matter described in this disclosure can provide one or more of the following advantages. The implementation of the subject matter reduces the difficulty of optimizing the rate and frequency of water wash injection within different hydrocarbon systems and their inherent operating variables. Further, it improves the efficiency of wash water injection by continuously adjusting the wash water injection rate to suit the real-time conditions of a system, thus eliminating excessive injection of wash water and risk of delayed actions. Similarly, the automatic nature of corrosion monitoring and control of the invention reduces the likelihood of human error compared to traditional methods of manual corrosion inspection conducted periodically. Another advantage is that by enabling remote and real-time monitoring of corrosion using the invention's installed sensors, the implementation optimizes the corrosion inspections process by eliminating the need for an inspector to physically travel between equipment due for inspection. The implementation also optimizes the process of corrosion level risk analysis and assessment by eliminating the need for corrosion engineers to collect and analyze the corrosion related data and determine the water injection rate and frequency.

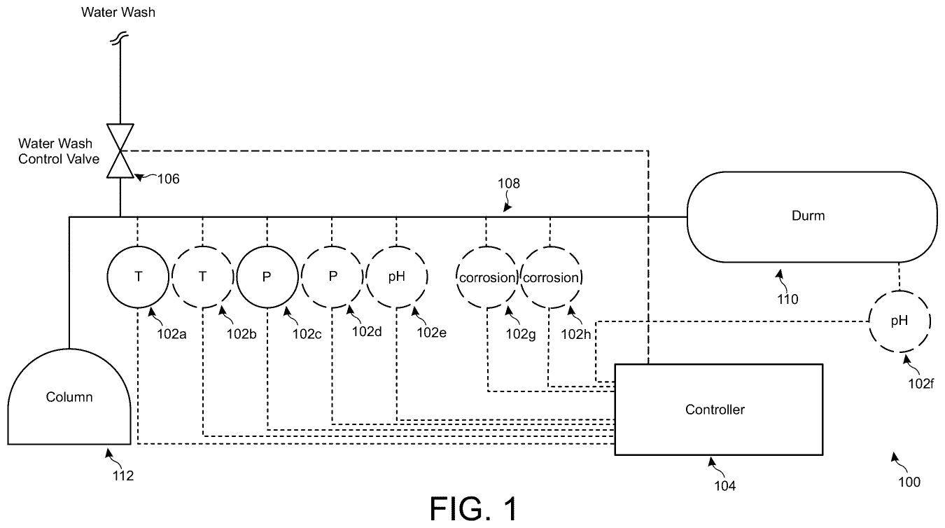

FIG. 1 illustrates an example of a system 100 for monitoring corrosion in a processing plant of a refinery through which hydrocarbon streams flow in piping. The system 100 includes a drum 110 to receive hydrocarbon streams. A column 112 processes the hydrocarbon streams before the streams are flowed to the drum 110. A piping 108 connects the drum 110 and the column 112. The system 100 further includes flow components such as pumps, valves, and instrumentation (not shown) to drive the fluid through the piping 108. The system 100 also includes a water wash control valve 106 connected to a water wash source (not shown). The water wash control valve 106 is equipped with a position controller to enable the valve to transmit a signal corresponding to the valve's position ranging from fully open to fully close. The water wash control valve 106 is configured to control the quantity of wash water injected into the system through the piping 108 based on its position. The system 100 can also includes control valves (not shown) for controlling the flowrate of additional fluids that control corrosion. The additional fluids can include a pH neutralizer fluid or a corrosion inhibitor fluid (not shown) (or both) for controlling the chemical composition of the system fluids.

As shown in FIG. 1, the system 100 includes multiple sensors 102a-h configured to measure target parameters within the system. Redundant sensors can be utilized within the system. That is, two sensors that measure the same target parameter can be implemented so that one of the sensors of one type can measure the target parameter in case the other sensor of the same type fails. In particular, the multiple sensors can include temperature sensors 102a-b, pressure sensors 102c-d, pH sensors 102e-f, and/or corrosion sensors 102g-h. The temperature sensors 102a-b are configured to measure the temperature of the fluid within the pipe structure to which the sensor is connected and to generate an electrical signal correlating to the measured temperature. The pressure sensors 102c-d are configured to measure the pressure of the fluid within the pipe structure to which the sensor is connected and to generate an electrical signal correlating to the measured pressure. The pH sensors 102e-f can be in the form of an analyzer or substantially similar pH measuring instruments that are configured to measure the pH of the fluid within the pipe structure to which the sensor is connected and to generate an electrical signal correlating to the measured pH value. The corrosion sensors 102g-h are configured to measure the corrosion rate of the pipe structure to which the sensor is connected and to generate an electrical signal correlating to the measured corrosion rate. The sensors 102a-h are configured to transmit the generated electrical signal to a controller described below. The sensors are connected to the piping 108 flowing a hydrocarbon stream between a column 112 and a drum 110. In some implementations, one or more of the sensors can be installed within the piping 108. In some implementations, one or more of the pH sensors can be connected to the drum 110. In addition to pH sensors 102e-f, fluid stream content sensors (not shown) can also be used to measure the stream content of certain corrosive fluids, e.g. chloride, and corrosion products, e.g. dissolved iron.

The system also includes a controller 104. In some implementations, the controller 104 can be a computer system including one or more processors and a computer-readable storage medium (e.g., a non-transitory computer-readable storage medium). The computer-readable storage medium is configured to store computer instructions. The one or more processors are configured to execute the computer instructions to perform the operations described here. The controller 104 is connected electronically to the system sensors 102a-h. The controller 104 is configured to receive electronic signals from the system sensors 102a-h. The controller 104 is connected electronically to the water wash control valve 106 (or any of the other control valves that control flow of other corrosion controlling fluids). The controller is configured to transmit computer instructions to control the water wash control valve 106 or any of the other control valves. The controller 104 is additionally configured to receive electronic signals from the water wash control valve 106 or any of the other control valves for determining the condition of the respective valves.

The controller 104 is configured to receive the generated electrical signal from the multiple sensors 102a-h to determine the current measured conditions of the system parameters (such as temperature, pressure, pH etc.). In some implementations, the controller 104 is configured to compare the measured parameters with a stored parameter threshold. The stored parameter thresholds are values stored within computer-readable storage medium of the microcontroller 104. The stored parameter thresholds may be manually selected by a user, selected by the microcontroller 104 based on historical data trends, determined by the microcontroller 104 based on mathematical equations, or a combination of such approaches. In some implementations, the controller 104 is configured to process the measured parameters to determine different system parameters that are indicative of corrosion, and to compare the determined system parameters with stored system parameter thresholds. Based on a result of comparing the measurements and stored parameter threshold (or comparing the determined corrosion parameters with stored corrosion parameter thresholds or both), the controller 104 controls a water wash valve 106 (or any of the other valves) that is fluidically coupled to the piping 108 to control a quantity of water injected through the water wash valve 106 into the piping 108. The controller 104 is configured to transmit signals to the water wash control valve 106 (or any of the other valves) to adjust its opening (or the openings of multiple valves) for increasing or decreasing the quantity of water injected into the piping 108 based on the outcome of the controller 104 computation. For example, the controller 104 can transmit a signal to the water wash control valve 106 to at least partially open to increase water injected into the piping 108 if measured parameters exceed a stored parameter threshold. Similarly, the controller 104 can transmit a signal to the water wash control valve 106 to at least partially close to reduce water injected into the piping 108 if the measured parameter falls below a stored parameter threshold. To prevent a case where two or more sensors are transmitting conflicting signals for controlling the water wash control valve 106, the controller 104 is may be configured to select a single parameter responsible for adjusting the valve opening. Alternatively, the controller 104 can be configured to rely on two or more parameters for controlling the water wash control valve 106 opening.

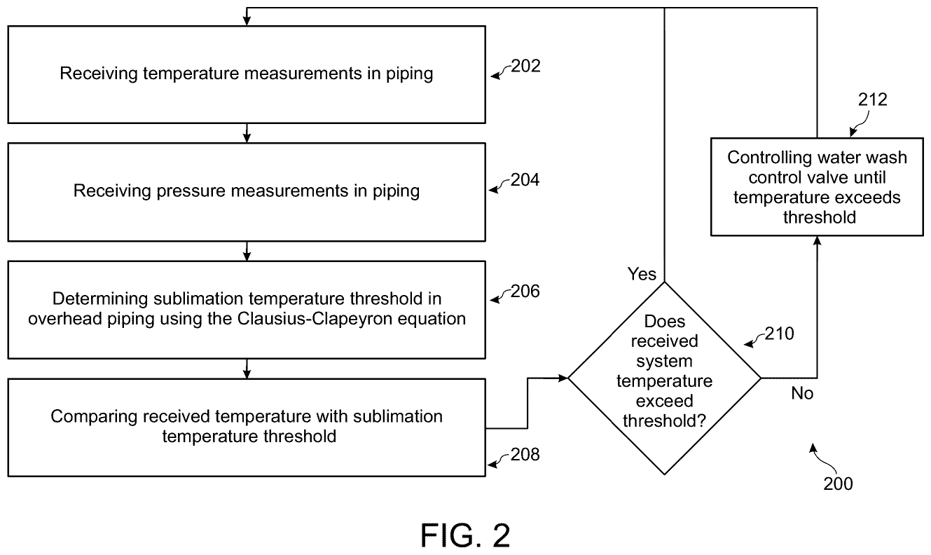

FIG. 2 is a flowchart of an example of a process of monitoring and mitigating corrosion based on a sublimation temperature parameter. In some implementations, the process 200 can be implemented by the controller 104. As shown in FIG. 2, at 202, the controller 104 receives a temperature measurement from one or more temperature sensors (e.g. temperature sensor 102a). The temperature measurement is an electrical signal produced by the temperature sensors 102a-b which correlates to the temperature of fluid in the system 100 at a particular instant as the fluid contacts the sensors.

At step 204, the controller 104 receives a pressure measurement from one or more pressure sensors (e.g. pressure sensor 102c). The pressure measurement is an electrical signal produced by the pressure sensors 102c-d which correlates to the pressure generated from the force of the fluid applied against the system and/or sensors in the system 100 at a particular instant.

At step 206, the controller 104 determines the sublimation temperature threshold of the system using the pressure measurements received from the sensors 102c-d. The sublimation temperature represents a temperature at and below which corrosive salts are formed in the overhead piping due to the flow of the hydrocarbon stream. The controller 104 determines the sublimation temperature using the Clausius-Clapeyron equation:

$${T}_{sub} = {T}_{ref} - ( \frac{R * ln ( \frac{{P}_{sys}}{{P}_{ref}} )}{Δ {H}_{sub}} ) \qquad ( Eq . 1 )$$

In Eq. 1, T_{sub} is the sublimation temperature, T_{ref} is a reference temperature where P_{ref} (reference sublimation pressure) is known, P_{sys} is the pressure measurement, ΔH_{sub} is the enthalpy of sublimation constant, and R is the universal gas constant. T_{ref}, P_{ref} and ΔH_{sub} are constants for a certain corrosive salt. T_{sub} determined by the controller 104 corresponds to a salt, e.g., a corrosive salt that is anticipated to form in the system 100. Each salt can contribute to the corrosion in the system 100. Each salt can have a corresponding T_{sub}. In such implementations, the controller 104 can execute Eq. 1 for each salt to determine a respective sublimation temperature and store the determined sublimation temperature. The computer system can compare the different determined sublimation temperatures with each other to identify the highest determined sublimation temperature. The controller 104 can assign the highest determined sublimation temperature as the sublimation temperature threshold. The controller 104 can use the assigned highest sublimation temperature threshold when comparing the sublimation temperature threshold with the received temperature measurement as performed in step 206.

At step 208, the controller 104 compares, in real-time, the system temperature and the determined sublimation temperature threshold. For the purposes of this disclosure, the terms “real-time,” “real time,” “realtime,” “real (fast) time (RFT),” “near (ly) real-time (NRT),” “quasi real-time,” or similar terms (as understood by one of ordinary skill in the art) mean that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit (or a combination of these or other functions) the data.

At step 210, the controller 104 evaluates a result of the comparing. If the controller 104 determines that the system temperature exceeds the determined sublimation temperature threshold (decision branch “YES”), the controller 104 repeats the method 200 as a feedback loop. Otherwise, if the controller 104 determines that the system temperature is less than the determined sublimation temperature threshold (decision branch “NO”), then, at step 212, the controller 104 opens the water wash control valve 106. To do so, the controller 104 transmits a signal to the water wash control valve 106 to open to allow a quantity of water to be injected through the water wash valve into the piping 108. The quantity of water injection is controlled by opening the water wash control valve 106 to inject more water. The degree and rate at which the valve opens may be configured based on the difference between the measured system condition and the stored threshold. Injecting water wash into the piping 108 reduces corrosion by flushing out generated corrosive salts that will be formed due to system temperature being less than sublimation temperature.

After controlling the water wash control valve 106 to open and inject more water, the controller 104 continues to monitor the parameters in real-time using the sensors 102a-d. The controller 104 uses the real-time parameter measurements of pressure to calculate the sublimation temperature threshold of the system 100 in real-time according to Equation 1. Once the controller 104 determines that the injected water from the water wash control valve 106 caused the system temperature to be higher than the determined sublimation temperature threshold, the controller 104 responsively sends a signal to close the water wash control valve 106 to inject less water into the system as needed. The controller 104 repeats the method 200 as a feedback loop.

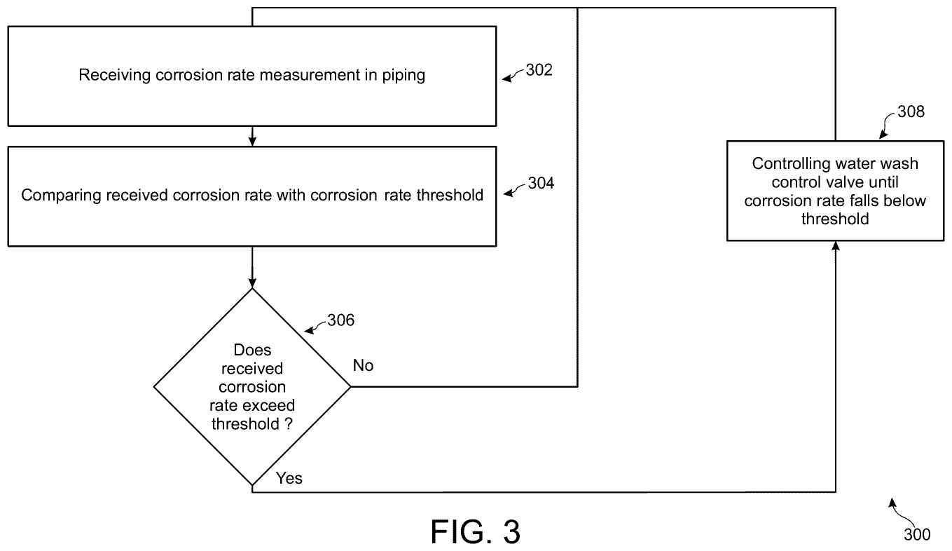

FIG. 3 is a flowchart of an example of a process of monitoring and mitigating corrosion based on a corrosion rate parameter. As shown in FIG. 3, at step 302, the controller 104 receives a corrosion rate measurement from one or more corrosion sensors (e.g. corrosion sensor 102g). At step 304, the controller 104 compares, in real-time, the measured corrosion rate and a stored corrosion rate threshold.

At step 306, the controller 104 evaluates a result of the comparing. If the controller 104 determines that the measured corrosion rate does not exceed the stored corrosion rate threshold (decision branch “NO”), then, the controller 104 repeats the method 300 as a feedback loop. Otherwise, if the controller 104 determines that the determined corrosion rate exceeds the stored corrosion rate threshold (decision branch “YES”), then, at step 308, the controller 104 opens the water wash control valve 106. To do so, the controller 104 transmits a signal to the water wash control valve 106 to open to allow a quantity of water to be injected through the water wash valve into the piping 108. The quantity of water injection is controlled by opening the water wash control valve 106 to inject more water. The degree and rate at which the valve opens may be configured based on the difference between the measured system condition and the stored threshold. Injecting water wash into the piping 108 neutralizes salts and acids and flushes out generated salts contributing to corrosion within the system 100 to mitigate the effects of corrosion.

After opening the water wash control valve 106 to inject more water, the controller 104 continues to monitor the corrosion rate parameters in real-time using one or more corrosion sensors (e.g. corrosion sensor 102g). Once the controller 104 determines that the injected water from the water wash control valve 106 has caused the corrosion rate to be lower than the stored corrosion rate threshold, the controller 104 responsively sends a signal to close the water wash control valve 106 to inject less water into the system as needed. The controller 104 repeats the method 300 as a feedback loop.

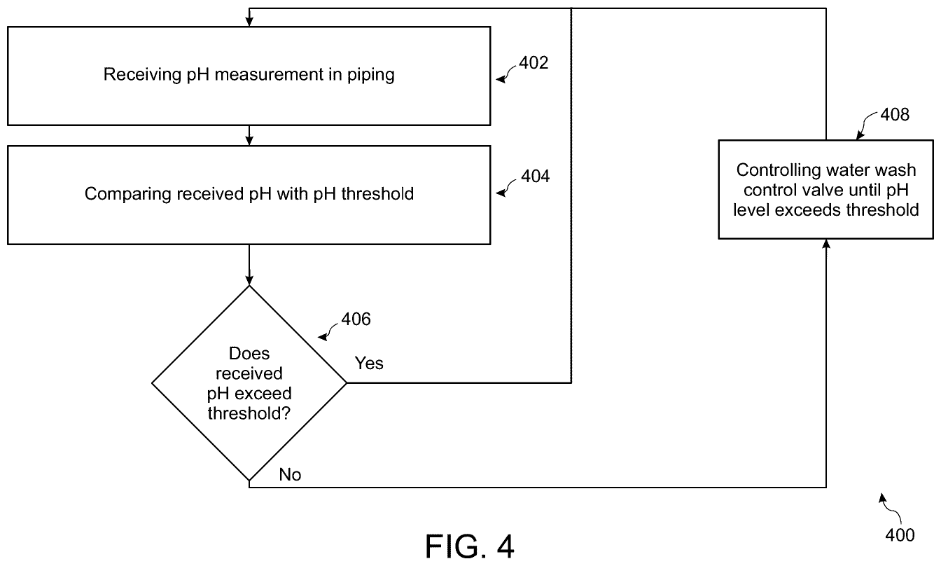

FIG. 4 is a flowchart of an example of a process of monitoring and mitigating corrosion based on a pH parameter. As shown in FIG. 4, at step 402, the controller 104 receives a pH level from one or more pH sensors (e.g. pH sensor 102e). At step 404, the controller 104 compares, in real-time, the measured pH and a stored pH threshold.

At step 406, the controller 104 evaluates a result of the comparing. If the controller 104 determines that the measured pH value is higher the stored pH threshold (decision branch “YES”), then, the controller 104 repeats the method 400 as a feedback loop. Otherwise, if the controller 104 determines that the measured pH is less than the stored pH threshold (decision branch “NO”), then, at step 408, the controller 104 opens the water wash control valve 106. To do so, the controller 104 transmits a signal to the water wash control valve 106 to open to allow a quantity of water to be injected through the water wash valve into the piping 108. The quantity of water injection is controlled by opening the water wash control valve 106 to inject more water. The degree and rate at which the valve opens may be configured based on the difference between the measured system condition and the stored threshold. Injecting water wash into the piping 108 increases pH of the system 100 by neutralizing acidity contributing to corrosion to mitigate the effects of corrosion.

After opening the water wash control valve 106 to inject more water, the controller 104 continues to monitor pH in real-time using one or more pH sensors (e.g. pH sensor 102e). Once the controller 104 determines that the injected water from the water wash control valve 106 caused the system pH to exceed the stored pH threshold, the controller 104 responsively sends a signal to close the water wash control valve 106 to inject less water into the system as needed. The controller 104 repeats the method 400 as a feedback loop. Based on user decision, the water wash control valve may also include fluid stream content sensors (not shown) that can be used to measure the stream content of certain corrosive fluids, e.g. chloride, and corrosion products, e.g. dissolved iron. Similar thresholds and logic can be applied to fluid stream content sensors in order to control the water wash control valve.

Certain aspects of the subject matter described here can be implemented as a method for monitoring corrosion in overhead piping of a Crude Distillation Unit. A computer system receives a temperature measurement and a pressure measurement measured by multiple sensors connected to an overhead piping of a CDU. The overhead piping flows a hydrocarbon stream between an atmospheric tower and an overhead drum of the CDU. The computer system determines a sublimation temperature threshold using the pressure measurement. The sublimation temperature represents a temperature at which corrosive salts are formed in the overhead piping due to the flow of the hydrocarbon stream. The computer system compares the determined sublimation temperature threshold and the received temperature measurement. Based on a result of comparing the determined sublimation temperature and the received temperature measurement, the computer system can control a water wash valve fluidically coupled to the overhead piping to control a quantity of water injected through the water wash valve into the overhead piping.

An aspect combinable with any other aspect includes the following features. The sublimation temperature is determined using the Clausius-Clapeyron equation.

An aspect combinable with any other aspect includes the following features. A respective sublimation temperature threshold is determined for each unique corrosive salt anticipated in the system using the Clausius-Clapeyron equation. To compare the determined sublimation temperature threshold and the received temperature measurement, the computer system compares the respective sublimation temperature for each corrosive salt with each other. Based on the comparison, the highest sublimation temperature at a given instance is chosen as the determined sublimation temperature threshold, which is stored in the logic controller's computer-readable storage for the comparison with the measured temperature.

An aspect combinable with any other aspect includes the following features. The computer system determines from the comparison that the measured temperature is lower than the determined temperature threshold. In response, the computer system controls the water wash valve to at least partially open to inject more water into the overhead piping.

An aspect combinable with any other aspect includes the following features. The computer system determines from the comparison that the measured temperature is higher than the determined temperature threshold. In response, the computer system controls the water wash valve to at least partially close to inject less water into the overhead piping.

An aspect combinable with any other aspect includes the following features. The computer system that receives a corrosion rate measurement compares the measurements with a predetermined stored corrosion rate threshold parameter. Based on the result of comparison, the computer system will control the water wash valve to adjust the quantity of water injected through the water wash valve into the overhead piping.

An aspect combinable with any other aspect includes the following features. The computer system receives the measurement of the corrosion rate by measuring the thickness of the overhead piping from a non-destructive testing (NDT) sensor or a corrosion probe connected to the overhead piping.

An aspect combinable with any other aspect includes the following features. The computer system receives a pH measurement for the overhead piping and/or the overhead drum. The computer system compares the measured pH value with a predetermined stored pH threshold parameter. Based on the result of comparison, the computer system will control the water wash valve to adjust the quantity of water injected through the water wash valve into the overhead piping.

Certain aspects of the subject matter described here can be implemented as a system for monitoring corrosion in an overhead piping flowing a hydrocarbon stream. Multiple sensors are connected to an overhead piping flowing a hydrocarbon stream, where the sensors are configured to measure the temperature and pressure of the hydrocarbon stream flowing through the overhead piping. A wash water control valve is fluidically coupled to the overhead piping and is configured to be controlled to control a quantity of water injected through the wash water control valve into the overhead piping. A computer system is made up of one or more processors along with a non-transitory computer-readable medium for storing computer instructions connected to the sensors and the wash water control valve. The computer system receives the system temperature and pressure and determines a sublimation temperature threshold using the received pressure. The computer system compares the measured system temperature and the determined sublimation temperature threshold. Based on a result of comparison, the computer system controls the water wash valve to control the quantity of water injected through the water wash valve into the overhead piping.

An aspect combinable with any other aspect includes the following features. The sublimation temperature is determined using the Clausius-Clapeyron equation.

An aspect combinable with any other aspect includes the following features. The Clausius-Clapeyron equation will produce a respective sublimation temperature threshold for each unique corrosive salt anticipated in the system. The computer system compares the respective sublimation temperature for each corrosive salt. Based on the comparison, the highest sublimation temperature at a given instance is chosen as the determined sublimation temperature threshold and is stored in the logic controller's computer-readable storage for the comparison with the measured temperature.

An aspect combinable with any other aspect includes the following features. If the computer system determines from the comparison between the measured temperature and the determined temperature threshold that the measured temperature is lower than the determined temperature threshold, the computer system controls the water wash valve to at least partially open to inject more water into the overhead piping.

An aspect combinable with any other aspect includes the following features. If the computer system determines from the comparison between the measured temperature and the determined temperature threshold that the measured temperature is higher than the determined temperature threshold, the computer system controls the water wash valve to at least partially close to inject less water into the overhead piping.

An aspect combinable with any other aspect includes the following features. The computer system receives a corrosion rate measurement to be compared with a predetermined stored corrosion rate threshold parameter. Based on the result of comparison, the computer system will control the water wash valve to adjust the quantity of water injected through the water wash valve into the overhead piping.

An aspect combinable with any other aspect includes the following features. The computer system acquires the measurement of the corrosion rate within the system by measuring the thickness of the overhead piping from a non-destructive testing (NDT) sensor or a corrosion probe connected to the overhead piping.

An aspect combinable with any other aspect includes the following features. The NDT sensor can comprise an ultrasonic test sensor or a guided wave sensor.

An aspect combinable with any other aspect includes the following features. The computer system receives a pH measurement for the overhead piping and/or the overhead drum. The computer system compares the measured pH value with a predetermined stored pH threshold parameter. Based on the result of comparison, the computer system will control the water wash valve to adjust the quantity of water injected through the water wash valve into the overhead piping.

Certain aspects of the subject matter described here can be implemented as a method for monitoring corrosion in overhead piping of a Crude Distillation Unit. Multiple sensors are connected to overhead piping of a Crude Distillation Unit (CDU). The sensors measure temperature and pressure measurements at a time instant of a hydrocarbon stream flowing through the overhead piping from an atmospheric tower to an overhead drum of the CDU. A computer system that is connected to the sensors determines a sublimation temperature for each time instant in the duration of time. The sublimation temperature represents a temperature at which corrosive salts are formed in the overhead piping due to the flow of the hydrocarbon stream. The computer system compares the measured temperature and the determined sublimation temperature threshold for each time instant in the duration of time. Based on a result of comparison, the computer system controls a water wash valve that is fluidically coupled to the overhead piping to control a quantity of water injected through the water wash valve into the overhead piping during the duration of time.

An aspect combinable with any other aspect includes the following features. The sublimation temperature is determined using the Clausius-Clapeyron equation.

An aspect combinable with any other aspect includes the following features. The Clausius-Clapeyron equation will produce a respective sublimation temperature threshold for each unique corrosive salt anticipated in the system. The computer system compares the respective sublimation temperature for each corrosive salt. Based on the comparison, the highest sublimation temperature at a given instance is chosen as the determined sublimation temperature threshold and is stored in the logic controller's computer-readable storage for the comparison with the measured temperature.

An aspect combinable with any other aspect includes the following features. The computer system receives a corrosion rate measurement to be compared with a predetermined stored corrosion rate threshold parameter. Based on the result of comparison, the computer system will control the water wash valve to adjust the quantity of water injected through the water wash valve into the overhead piping.

An aspect combinable with any other aspect includes the following features. The computer system receives a pH measurement for the overhead piping and/or the overhead drum. The computer system compares the measured pH value with a predetermined stored pH threshold parameter. Based on the result of comparison, the computer system will control the water wash valve to adjust the quantity of water injected through the water wash valve into the overhead piping.

An aspect combinable with any other aspect includes the following features. The control of the corrosion within the system involves the opening of the wash water valve to inject more water into the overhead piping.

Several implementations of the subject matter have been described. Other implementations, alterations, and permutations of the described implementations are within the scope of the following claims as will be apparent to those skilled in the art.

1. A method for monitoring corrosion in overhead piping of a Crude Distillation Unit, the method comprising:
receiving, by a computer system, a temperature measurement and a pressure measurement measured by a plurality of sensors connected to an overhead piping of a Crude Distillation Unit (CDU), the overhead piping flowing a hydrocarbon stream between an atmospheric tower and an overhead drum of the Crude Distillation Column;
determining, by the computer system, a sublimation temperature threshold using the pressure measurement, wherein the sublimation temperature represents a temperature at which corrosive salts are formed in the overhead piping due to the flow of the hydrocarbon stream;
comparing, by the computer system, the determined sublimation temperature threshold and the received temperature measurement; and
based on a result of comparing the determined sublimation temperature and the received temperature measurement, controlling, by the computer system, a water wash valve fluidically coupled to the overhead piping to control a quantity of water injected through the water wash valve into the overhead piping.

2. The method of claim 1, wherein the sublimation temperature is determined using the Clausius-Clapeyron equation:
$${T}_{sub} = {T}_{ref} - ( \frac{R * ln ( \frac{{P}_{sys}}{{P}_{ref}} )}{Δ {H}_{sub}} ) ,$$
wherein T_{sub} is the sublimation temperature, T_{ref} is the temperature measurement, P_{ref} is a reference sublimation pressure constant, P_{sys} is the pressure measurement, ΔH_{sub} is the enthalpy of sublimation constant, and R is the universal gas constant.

3. The method of claim 1, further comprising determining a respective sublimation temperature threshold for each unique corrosive salt anticipated in the system, wherein comparing the determined sublimation temperature threshold and the received temperature measurement comprises:
comparing the respective sublimation temperature threshold for each unique corrosive salt with each other; and
based on a result of comparing the respective sublimation temperature threshold for each unique corrosive salt with each other, identifying the highest sublimation temperature threshold as the determined sublimation temperature threshold.

4. The method of claim 1, wherein the received temperature measurement is lower than the determined sublimation temperature threshold, wherein the method further comprises controlling the water wash valve to at least partially open to inject water into the overhead piping.

5. The method of claim 4, wherein the received temperature measurement is greater than the determined sublimation temperature threshold, wherein the method further comprises controlling the water wash valve to at least partially close to inject less water into the overhead piping.

6. The method of claim 1, further comprising:
determining a corrosion level for the overhead piping;
comparing the received corrosion level and a stored corrosion level threshold; and
based on a result of comparing the determined corrosion level and the stored corrosion level threshold, further controlling the water wash valve to control the quantity of water injected through the water wash valve into the overhead piping.

7. The method of claim 6, wherein determining the corrosion level comprises:
receiving a thickness of the overhead piping from a non-destructive testing (NDT) sensor or a corrosion probe connected to the overhead piping; and
determining the corrosion level for the overhead piping using the received thickness.

8. The method of claim 1, wherein the hydrocarbon stream flows to the overhead drum, wherein the method further comprises:
receiving a pH value for the overhead piping and/or the overhead drum;
comparing the received pH value and a stored pH value threshold; and
based on a result of comparing the received pH value and the stored pH value threshold, further controlling the water wash valve to control the quantity of water injected through the water wash valve into the overhead piping and overhead drum.

9. A system for monitoring corrosion in an overhead piping flowing a hydrocarbon stream, the system comprising:
a plurality of sensors connected to an overhead piping flowing a hydrocarbon stream, the plurality of sensors configured to measure a temperature and a pressure of the hydrocarbon stream flowing through the overhead piping;
a wash water control valve fluidically coupled to the overhead piping, the wash water control valve configured to be controlled to control a quantity of water injected through the wash water control valve into the overhead piping; and
a computer system connected to the plurality of sensors and the wash water control valve, the computer system comprising:
one or more processors; and
a non-transitory computer-readable medium storing computer instructions, which when executed by the one or more processors cause the one or more processors to perform operations comprising:
receiving the system temperature and pressure;
determining a sublimation temperature threshold using the received pressure, wherein the sublimation temperature threshold represents a temperature at which corrosive salts are formed in the overhead piping due to the flow of the hydrocarbon stream;
comparing the measured system temperature and the determined sublimation temperature threshold; and
based on a result of comparing the measured temperature and the determined sublimation temperature threshold, controlling the water wash valve to control the quantity of water injected through the water wash valve into the overhead piping.

10. The system of claim 9, wherein the sublimation temperature is determined using the Clausius-Clapeyron equation:
$${T}_{sub} = {T}_{ref} - ( \frac{R * ln ( \frac{{P}_{sys}}{{P}_{ref}} )}{Δ {H}_{sub}} ) ,$$
wherein T_{sub} is the sublimation temperature, T_{ref} is the temperature measurement, P_{ref} is a reference sublimation pressure constant, P_{sys} is the pressure measurement, ΔH_{sub} is the enthalpy of sublimation constant, and R is the universal gas constant.

11. The system of claim 9, further comprising determining a respective sublimation temperature threshold for each unique corrosive salt anticipated in the system, wherein comparing the determined sublimation temperature threshold and the received temperature measurement comprises:
comparing the respective sublimation temperature threshold for each unique corrosive salt with each other; and
based on a result of comparing the respective sublimation temperature threshold for each unique corrosive salt with each other, identifying the highest sublimation temperature threshold as the determined sublimation temperature threshold.

12. The system of claim 9, wherein the received measured temperature is lower than the determined sublimation temperature threshold, wherein the operations further comprise controlling the water wash valve to at least partially open to inject water into the overhead piping.

13. The system of claim 9, wherein the received measured temperature is greater than the determined sublimation temperature threshold, wherein the operations further comprise controlling the water wash valve to at least partially close to inject less water into the overhead piping.

14. The system of claim 9, wherein the plurality of sensors comprises a corrosion sensor connected to the overhead piping, wherein the operations further comprise:
determining a corrosion level for the overhead piping based on a corrosion measurement by the corrosion sensor;
comparing the received corrosion level and a stored corrosion level threshold; and
based on a result of comparing the determined corrosion level and the stored corrosion level threshold, further controlling the water wash valve to control the quantity of water injected through the water wash valve into the overhead piping.

15. The system of claim 14, wherein the corrosion sensor is a non-destructive testing (NDT) sensor or a corrosion probe connected to the overhead piping, wherein the NDT sensor is configured to measure a thickness of the overhead piping.

16. The system of claim 15, wherein the NDT sensor comprises an ultrasonic test sensor or a guided wave sensor.

17. The system of claim 9, wherein the overhead piping is fluidically coupled to a drum to receive the hydrocarbon stream flowing through the overhead piping, wherein the plurality of sensors comprises a pH sensor installed within the overhead piping or the overhead drum, wherein the operations further comprise:
receiving a pH value for the overhead piping based on a pH value measurement by the pH sensor;
comparing the received pH value and a stored pH value threshold; and
based on a result of comparing the received pH value and the stored pH value threshold, further controlling the water wash valve to control the quantity of water injected through the water wash valve into the overhead piping and/or drum.

18. A method for monitoring corrosion in overhead piping of a Crude Distillation Unit, the method comprising:
measuring, by a plurality of sensors connected to overhead piping of a Crude Distillation Unit (CDU) and over a duration of time, a plurality of temperature measurements and a plurality of pressure measurements, each temperature measurement and each pressure measurement representing temperature and pressure, at a time instant, of a hydrocarbon stream flowing through the overhead piping from an atmospheric tower to an overhead drum of the CDU;
determining, by a computer system connected to the plurality of sensors, and for each time instant in the duration of time, a sublimation temperature, wherein the sublimation temperature represents a temperature at which corrosive salts are formed in the overhead piping due to the flow of the hydrocarbon stream;
comparing, by the computer system, and for each time instant in the duration of time, the measured temperature and the determined sublimation temperature threshold; and
based on a result of comparing the measured temperature and the determined sublimation temperature threshold, controlling, by the computer system and for each time instant in the duration of time, a water wash valve fluidically coupled to the overhead piping to control a quantity of water injected through the water wash valve into the overhead piping during the duration of time.

19. The method of claim 18, wherein, at each instant of time, the sublimation temperature is determined using the Clausius-Clapeyron equation:
$${T}_{sub} = {T}_{ref} - ( \frac{R * ln ( \frac{{P}_{sys}}{{P}_{ref}} )}{Δ {H}_{sub}} ) ,$$
wherein T_{sub} is the sublimation temperature, T_{ref} is the temperature measurement at each instant of time, P_{ref} is a reference sublimation pressure constant, P_{sys} is the pressure measurement at each instant of time, ΔH_{sub} is the enthalpy of sublimation constant, and R is the universal gas constant.

20. The method of claim 18, further comprising determining a respective sublimation temperature threshold for each unique corrosive salt anticipated in the system, wherein comparing the determined sublimation temperature threshold and the received temperature measurement comprises:
comparing the respective sublimation temperature threshold for each unique corrosive salt with each other; and
based on a result of comparing the respective sublimation temperature threshold for each unique corrosive salt with each other, identifying the highest sublimation temperature threshold as the determined sublimation temperature threshold.
